(19) United States
(12) Patent Application Publication
(10) Pub. No.: US 2008/0232125 A1
(43) Pub. Date: Sep. 25, 2008

(54) Method for Fixing a Light-Emitting Diode to a Metallic Heat-Radiating Element

(75) Inventors: Harald Willwohl, Aachen (DE); Karl-Heinz Hohaus, Linnich (DE); Hans-Josef Kohl, Aachen (DE); Ralph Hubert Peters, Maastricht (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/088,436

(22) PCT Filed: Sep. 19, 2006
(86) PCT No.: PCT/IB2006/053363

§ 371 Date: Mar. 28, 2008

(30) Foreign Application Priority Data
Sep. 29, 2005 (EP) 05108987.8

(51) Int. Cl. B23K 31/02; B60Q 1/00

(52) U.S. Cl. 362/487; 228/136

(57) ABSTRACT

The application relates to light emitting devices. In order to provide good heat dissipation and easy adjustment of the lighting devices, there is provided to fix a light-emitting diode (12) having a metallic base (10) to a metallic heat-radiating element (18), which fixing comprises substance-to-substance bonding the base of the diode to a metallic sleeve (14), positioning the sleeve on the heat-radiating element such that the sleeve mantles the heat-radiating element, and connecting the sleeve with the heat-radiating element.

The present application relates to a method for fixing a light-emitting diode having a metallic base to a metallic heat-radiating element. The application further relates to a lighting device, as well as the use of such a lighting device.

Lighting devices comprising light-emitting diodes (LEDs) can be used in automotive applications. For example, front and rear lighting devices can utilize LEDs as lighting elements. It has been found that rear combination lamps (RCL), and daytime running lights (DRL) can be equipped with LED modules.

However, LED modules are sensitive to ambient heat. First, the maximum junction temperature of LED modules is limited. Further, the light output of LED modules, in particular of AlInGaP LEDs strongly decreases with increasing junction temperature. Nevertheless, in automotive applications, the ambient temperature during operation may be up to 85° C. for rear lighting and 105° C. for front lighting.

Therefore, it is of the utmost importance for the performance of LED modules to have a good thermal management. It is known that a heat sink can be thermally connected to the LED by mechanical contact, heat conductive glue, or heat conductive tape. However, all of these solutions have the disadvantage that the heat flow is either limited by the thermal conductivity and the thickness of the interface material, or by a small air gap.

It has been proposed in the art to provide a direct copper bonding between the metallic base of the LED and the metallic heat-radiating element. For example in US 2004/0190294 A1, a method for fixing the LED to a heat radiating element by laser spot welding is described. It is described that a heat-radiating element can be fixed to the metallic base of the LED by laser spot welding. In order to provide a good contact, the heat-radiating element can be coated with a layer of metal, for example, nickel, which is able to absorb the energy of the laser light well. The presence of this nickel layer helps to establish an effective weld, and thus a good substance-to-substance bonding.

Besides good heat dissipation, LED modules need to be aligned in order to provide good lighting. This means that the LED modules need to be directed all in one direction in order to provide good lighting. In case the direction of lighting of the LEDs differs, the overall lighting is not well exploited.

In order to ensure the correct geometric positioning of the LED on the radiating element, US 2004/0190294 A1 proposes to provide assistance for the positioning of the diode on the surface of the radiator. It is proposed that there is produced, via a cutting tool, a physical centering means in the form of one or more projections on the surface of the radiator. These projections can co-operate with the contour of the LED in order to provide the correct geometric positioning. However, the main lighting direction of the diodes cannot be corrected according to such a known device.

Therefore, it is an object of the application to provide a method for fixing LEDs with improved lighting capabilities. It is a further object to provide a lighting device, which exploits the emitted light of all diodes. Another object of the application is to provide easy manufacturing of lighting diodes on a heat-radiating element.

To solve one or more of these objects, the application provides a method for fixing a light-emitting diode having a metallic base to a metallic heat-radiating element comprising substance-to-substance bonding the base of the diode to a metallic sleeve, positioning the sleeve on the heat-radiating element such that the sleeve mantles the heat-radiating element, and connecting the sleeve with the heat-radiating element.

The light-emitting diode is preferably a power light-emitting diode, which thermal energy to be dissipated requires a specific metallic base. Power diodes are generally provided with a metallic base, for example, made of copper. This metallic base enables to establish a substance-to-substance bonding with a metallic sleeve. The metallic sleeve is an element, which is provided in between the metallic base of the diode and the heat-radiating element. The metallic sleeve is formed such that is can mantle the heat-radiating element. It is preferred that the heat-radiating element is formed bolt-like and that the sleeve can mantle this bolt.

In order to enable good alignment of the diode on the heat-radiating element, the diode is first substance-to-substance bonded to the sleeve, the sleeve is then aligned on the heat-radiating element, and thereafter the sleeve is connected to the heat-radiating element. By this it is possible to provide a good bonding between the diode and the sleeve, and also to provide a good alignment of the diode on the heat-radiating element.

Positioning and/or alignment of the sleeve on the heat-radiating element may occur by both active and passive means. During active and passive adjustment and/or positioning the heat-radiating element is mounted in a holder in a defined way with respect to its internal reference elements. These reference elements (e.g. reference pins, or bayonet extensions) are used in the interface to the lamp housing in order to establish a precise positioning of the module to the lamp housing during application. In case of an active positioning process the LED is electrically contacted and switched on. The desired light distribution is adjusted by at least 3-axis positioning of the sleeve on the heat-radiating element. The light distribution is monitored e.g. by a vision system. In case of passive positioning, the vision system monitors the position of the LED in three directions and the tilt of the LED with respect to the forward direction. After correct positioning of the LED the sleeve is connected and fixed to the heat-radiating element.

Embodiments provide welding the base of the diode to the metallic sleeve. This welding can be, for example, a laser spike welding process. During such a process, a laser beam melts the material of the metallic sleeve to the slug material, e.g. the metallic base, of the LED. As a result, a direct metallic material joint, with both an optimized thermal conductivity and a high mechanical strength, is achieved. The heat-radiating element can be a passive cooling heat sink, transferring the generated heat to the ambient through a sufficiently large surface. The heat-radiating element can also be a heat pipe, and the sleeve can be directly joined with the hot end of the heat pipe.

In order to provide a metallic sleeve with good welding properties, embodiments provide the sleeve made of copper, nickel, or alloys therefrom. However, the sleeve material may be made of any laser weldable material with a high thermal conductivity.

According to embodiments, the thickness of the sleeve is typically between 0.1 mm and 1 cm. The sleeve may be joined to the metallic base of the diode by forming a thin layer of an inter-metallic phase between the metallic base of the diode and the material of the sleeve. Such an inter-metallic phase may be formed by a rapid local heating up of both materials in close contact.

After the diode has been connected to the sleeve, the sleeve needs to be positioned on the heat-radiating element. In order to provide good positioning and alignment, embodiments provide swivelling the sleeve around the longitudinal axis of the heat-radiating element, such that the light-emitting diode is aligned on the heat-radiating element. Thus, the diode can be aligned by moving the sleeve on the heat-radiating element. The direction of light emission can thus be adjusted.

In order to provide good adjustment capabilities, the sleeve is formed cup-shaped. The cup can be positioned on the heat-radiating element and swivelled around the longitudinal axis of the heat-radiating element. It is also preferred that the heat-radiating element is formed such that it fits into the sleeve. This can be a bolt-like form.

In order to enable the sleeve to be swivelled around the longitudinal axis of the heat-radiating element, embodiments provide forming the heat-radiating element tapering to its end-face. It is also preferred that the end-face of the heat-radiating element is semicircular.

After having aligned the LED with the sleeve on the heat-radiating element, the assembly needs to be fixed. Therefore, embodiments provide connecting the sleeve with the heat-radiating element by formfitting the sleeve with the heat-radiating element. This can be done either by substance-to-substance bonding, or by electromagnetic forming of the sleeve. This provides a mechanically strong connection between the sleeve and the heat-radiating element.

A further aspect of the application is a lighting device comprising a light-emitting diode having a metallic base, a sleeve, and a heat-radiating element, wherein the base is substance-to-substance bonded to the sleeve, and wherein the sleeve is fixed to the heat-radiating element.

Another aspect of the application is the use of such a lighting device for car lighting, in particular for rear combination lights or date time running lights.

These and other aspects of the application will apparent from and elucidated with reference to the following Figures. In the Figures show:

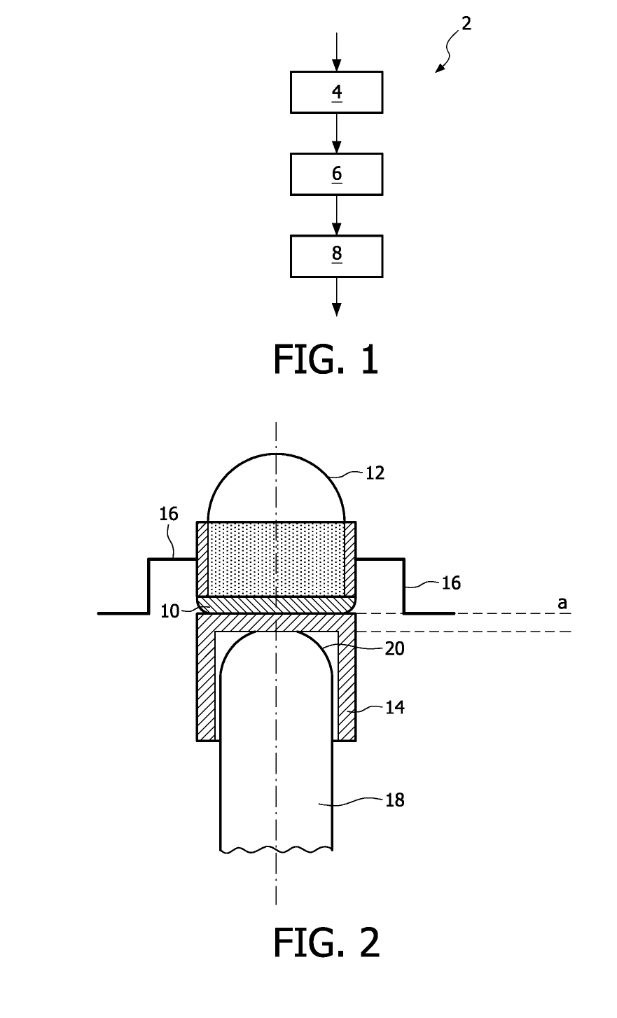

FIG. 1 a flowchart of a method according to the application;

FIG. 2 a side view of a lighting device according to the application

FIG. 1 illustrates a method 2 for assembling a lighting device, as illustrated in FIG. 2. In a first step 4, a base 10 of an LED 12 is bonded to a metallic sleeve 14.

As illustrated in FIG. 2, the LED 12 comprises electrodes 16 and the metallic base 10. The metallic base 10 is preferably made of copper. In the bonding step 4, the metallic base 10 is bonded to the sleeve 14. This can be done by rapid local heating-up of both materials of the metallic base 10, and the sleeve 14 to provide an inter-metallic phase between the elements. Preferably, this heating-up can be done by welding, preferably by a laser welding process, such as laser spike welding.

The sleeve 14 is preferably made of CuNi, and has a thickness a between 0.1 mm and 10 mm.

After the metallic base 10 has been bonded to the sleeve 14, the sleeve 14 is positioned in step 6 on the heat-radiating element 18.

This positioning can be done by swivelling the sleeve 14 around the longitudinal axis X of the heat-radiating element 18. The heat-radiating element 18 is formed bolt-like. The end-face 20 of the heat-radiating element 18 is formed semicircular. By that, the sleeve 14 can be easily swivelled to align the LED 10 on other LEDs, and to control the direction of emitted light.

The heat-radiating element 18 can be a passive cooling heat sink, as well as a heat pipe. The end-face 20 can be the hot end of the heat pipe.

As can be seen, the end face 20 of the heat-radiating element 12 is in close fit with the sleeve 14.

After the sleeve 14 is positioned on the end-face 20 of the heat-radiating element 18, the sleeve 14 is connected in step 8 to the heat-radiating element 18.

This connection can be done by substance-to-substance bonding as well as electro-magnetic forming. During electromagnetic forming, the sleeve 14 is formed to closely fit the end-face 20 of the heat-radiating element 18.

The thermal conductance of the interface between the metallic base 10 and the end-face 20 may be adjusted by the sleeve material, the thickness of the sleeve material, and the number and diameter of the welding points between the base 10 of LED 12 and the sleeve 14. The welding points can be on parallel lines in the diameter of the metallic base 10, as well as arranged coaxially around the center of the metallic base 10.

The welding points can be arranged preferably in such a way that the contact area between sleeve and heat-radiating element is optimized, in order to minimize the thermal resistance between sleeve and heat-radiating element.

The described method enables assembling lighting devices, which have good heat dissipating properties as well as good aligning properties. Further, the lighting devices can be used for automotive applications, but also for general lighting application, signals, etc.

1. Method for fixing a light-emitting diode having a metallic base (10) to a metallic heat-radiating element (18) comprising
substance-to-substance bonding the base (10) of the diode to a metallic sleeve (14),
positioning the sleeve (14) on the heat-radiating element (18) such that the sleeve (14) mantles the heat-radiating element (18), and
connecting the sleeve (14) with the heat-radiating element (18).

2. Method of claim 1, wherein substance-to-substance bonding comprises welding the base (10) of the diode to the metallic sleeve (14).

3. Method of claim 2, wherein welding the base (10) of the diode to the metallic sleeve (14) comprises laser spike welding.

4. Method of claim 1, further comprising forming the sleeve (14) using Copper, Nickel, or alloys therefrom.

5. Method of claim 1, further comprising forming the sleeve (14) with a thickness of 0.1 mm-10 mm.

6. Method of claim 1, wherein positioning the sleeve (14) on the heat-radiating surface comprises swivelling the sleeve (14) around the longitudinal axis (X) of the heat-radiating element (18) such that the diode is aligned on the heat-radiating element (18).

7. Method of claim 1, further comprising forming the sleeve (14) cup-shaped.

8. Method of claim 1, further comprising forming the heat-radiating element (18) to fit at least partially into the interior of the sleeve (14).

9. Method of claim 1, further comprising forming the heat-radiating element (18) tapering to the end-face (20).

10. Method of claim 1, further comprising forming the head-radiating element (18) with a semicircular end-face (20).

11. Method of claim 1, wherein connecting the sleeve (14) with the heat-radiating element (18) comprises formfitting the sleeve (14) with the heat-radiating element (18).

12. Method of claim 1, wherein connecting the sleeve (14) with the heat-radiating element (18) comprises substance-to-substance bonding.

13. Method of claim 1, wherein connecting the sleeve (14) with the heat-radiating element (18) comprises electromagnetic forming.

14. A lighting device comprising a light-emitting diode having a metallic base (10), a sleeve (14), and a heat-radiating element (18), wherein the base (10) is substance-to-substance bonded to the sleeve (14) and wherein the sleeve (14) is fixed to the heat-radiating element (18).

15. Use of a lighting device of claim 14, for car lighting, in particular for rear combination lights or daytime running lights.
